(19) United States
(12) Patent Application Publication
(10) Pub. No.: US 2013/0060652 A1
(43) Pub. Date: Mar. 7, 2013

(54) INCREASING THE UTILITY OF OPPORTUNISTIC AND TIME CRITICAL GOODS AND SERVICES

(71) Applicants: Mark Calvano, San Francisco, CA (US); Glen McLaughlin, San Carlos, CA (US)

(72) Inventors: Mark Calvano, San Francisco, CA (US); Glen McLaughlin, San Carlos, CA (US)

(21) Appl. No.: 13/603,841

(22) Filed: Sep. 5, 2012

Related U.S. Application Data
(63) Continuation-in-part of application No. 13/485,560, filed on May 31, 2012.
(60) Provisional application No. 61/491,880, filed on May 31, 2011.

(51) Int. Cl. G06Q 30/08

(52) U.S. Cl. 705/26.3

(57) ABSTRACT

Embodiments of the present invention provide a service to goods and/or service providers and consumers in the traditional context of a “first-come, first-served queue” or “class based” queue. A provider presents a listing of one or offerings to consumers to solicit bids for a good or service associated with the offering. After receiving an acceptable bid from a user, the provider provides feedback regarding the bid that indicates the ranking of the user with respect to other bidders in the bidding process. Based on the feedback, the user may submit a modified bid. Following confirmation of a bid by a user, a winning bid is determined and the user is notified.

### CROSS-REFERENCE TO RELATED APPLICATIONS

The present application is a continuation-in-part and claims the priority benefit of U.S. patent application Ser. No. 13/485,560 filed May 31, 2012 and entitled “Increasing the Utility of Opportunistic and Time Critical Goods and Services” which claims the priority benefit of U.S. provisional application No. 61/491,880 filed May 31, 2011 and entitled “Increasing the Utility of Opportunistic and Time Critical Goods and Services.” The disclosures of each of the aforementioned applications are incorporated herein by reference.

### BACKGROUND OF THE INVENTION

1. Field of the Invention

The present invention generally relates to the purchase or acquisition of sold out or oversubscribed goods or services. More specifically, the present invention relates to increasing the utility and profit margin of a provider of those goods or services while generating increased consumer satisfaction and long term good will amongst the provider and consumer.

2. Description of the Related Art

Organizations have established numerous methods for handling customer demands. The two most common methodologies are “first-come, first-served” and “class based.” Restaurants, nightclubs, and movies theaters typically utilize the “first-come, first-served” methodology. The “class based” methodology is primarily used in the transportation industry (e.g., travel by air or train) and in live entertainment venues (e.g., a football game, live concert, or the opera).

In the “first-come, first-served” methodology, patrons who have waited the longest for a good or service are the first to be rewarded with the good or service. Ancillary biases or preferences are generally not taken into account. For example, in a movie theater, the first person in a ticket queue will pay the same value for a ticket as the last person in the ticket queue. The first person will, have the first choice in seating in the movie theater because of their early arrival while the last person will be required to select among less desirable seats that remain.

In a “class based” service methodology, a formalized seating policy is implemented where the most desirable seats are allocated a higher price and those that are willing to pay that price are awarded the corresponding seat. The point in time at which a consumer purchases the seat is irrelevant—only the price (and the remaining inventory of those seats) is at issue. Thus, a person paying the premium price for a more desirable seat will be allowed to enjoy that seat even if they make the purchase shortly before an event commences.

One major shortcoming of these methods is that they do not optimize the experience of any given consumer or the profits of the good/service provider. As a result, overall customer loyalty is not maximized and, in some instances, may even be reduced. On a daily basis, any number of potential revenue generating events is not capitalized due to the lack of knowledge of the value placed on a particular good or service by an individual consumer or group of consumers.

An airline, for example, will fly regularly scheduled routes without having the first or business class sections fully populated even though there may be a number of people ticketed in the economy class that would be willing to pay an additional fee for a seating upgrade. The airline industry—like any number of other industries and vendors—do not have an effective method of knowing which customers would be willing to purchase an upgrade or the appropriate amount to charge a customer without undermining business with passengers who have paid the full fare amount.

Programs exist that take into account customer loyalty whereby a provider subsequently attempts to reward that loyalty. The best example of this practice is “frequent flyer” miles that are accumulated by a traveler and then redeemed with the airline for rewards such as a seat upgrade or reduced ticket price. These programs, however, remain dependent upon the traditional “class based” service methodology whereby limited additional freedoms are offered to the customer.

There is a need in the art for organizations to maximize their opportunistic based profits while enhancing the overall customer experience. Consequently, there exists the need to better capitalize upon revenue generating goods and services by providing knowledge to a provider regarding the value placed on particular good or service by the consumers.

### SUMMARY OF THE CLAIMED INVENTION

An embodiment performs a method for acquiring a time critical offering. An offering is provided to a user in a queue to receive the offering. The offering includes a good or service offered by a provider. A monetary bid is received from the user for the offering. A determination is made that the bid meets one or more parameters provided by the provider. The parameter may include a minimum monetary amount for the bid. The user's position in the queue may then be improved based the user's bid.

An embodiment acquires a time critical offering. An offering may be presented to a user. The offering may include a good or service offered by a provider. A monetary bid may then be received from the user for the offering. A determination may be made that the bid meets one or more parameters indicated by the provider. The parameter including a minimum monetary amount for the bid. A determination may then be made that the bid is a winning bid, the winning bid having the highest monetary component amongst all other bidders. The user may then be notified that the user has placed the winning bid.

An embodiment may include a system for acquiring a time critical offering. The system may include a memory, a communication channel and one or modules. The memory may store one or more parameters indicated by a provider. The communication channel may receive a monetary bid from a user and a confirmation from the user that the user remains bound to the bid. The one or more modules may be stored in memory and executable by a processor to present an offering to a user in a queue to receive the offering. The offering may include a good or service offered by a provider. A determination may be made that the bid meets one or more parameters indicated by the provider. The parameter including a minimum monetary amount for the bid. Feedback may be provided to the user regarding the bid following acceptance of the bid by the provider. The feedback may indicate a ranking of the user against one or more other bidders in the queue. The user may be notified that the user is at the front of the queue.

### BRIEF DESCRIPTION OF THE DRAWINGS

FIG. 1 illustrates a system for a transaction process between a user and a vendor.

FIG. 2 illustrates a system including a user, vendor, and different partner customer relationship management systems.

FIG. 3 illustrates a user experience system.

FIG. 4 illustrates a vendor strategy system.

FIG. 5 illustrates a method for client based interactions in a queue based system.

FIG. 6 illustrates a method for client based interactions in a class based system.

FIG. 7 illustrates a user interface for user interaction.

### DETAILED DESCRIPTION

Embodiments of the present invention allow a provider of goods and/or services to maximize opportunistic based profits while enhancing the overall customer experience. A goods or service provider may use the service to increase revenue. For example, with respect to the airline industry, the service seeks to obtain the maximum price that the market will bear for airfare immediately prior to departure of a flight by using a bidding process whereby an interested customer may bid on an offering from the airline such as an available seat or a seat upgrade. Obtaining the maximum value for a particular seat is based on a fixed price bid format as well as other factors such as the original price of the ticket the consumer paid or the consumer's status with the airline's customer loyalty program(s). With these factors in mind, a customer may offset the amount they would need to bid to achieve an upgraded seat.

After receiving a bid from a consumer, the airline may show the current customers on an upgrade list as well as their priority. This information may be used to inform the customers of the sufficiency of their bids and if an increased bid is required. This information may be displayed in a public area such as a check-in area or departure gate, as well as on (or alternatively on) a mobile communication device of the customer. With this bid and priority information in hand—in a public or private arena—the customer is able to adjust the original bid. In other words, the customer is able to modify a bid based on a subjective value for the good or service.

Embodiments of the present invention also allow a vendor or provider to set one or more parameters for what constitutes an acceptable offer. A vendor, for example, may require a minimum offer or a threshold that needs to be met before an offer is valid. Such a requirement would be similar to a minimum bid at an auction. These parameters could also be adjusted based on a variety of factors such as (in the context of the airline industry) the type of flight (e.g., international or domestic), the duration of the flight based on distance or hours, the seasonality of the flight (i.e., spring, summer, winter or fall), and major events that correspond to the flight (e.g., the World Cup or the Olympics). The vendor would thus be able to have granular control over any number of parameters associated with the flight. This control may work in conjunction with existing loyalty programs thereby allowing customers to optimize their experience based on the individual value placed on the good or service.

Embodiments of the present invention may allow a consumer to acquire desired goods or services, discounts, and promotions in a more timely fashion and in some cases, with discounted pricing. While described above in relation to the airline industry, a consumer is able to make bids for desired goods and services in other industries and venues having a time critical component or event such as hotels, nightclubs, restaurants, sporting events, boat cruises, trains, parks, museums, fairs, and new product releases.

The service may also apply to the hospitality industry with a hotel accommodations as an example of an oversubscribed item of a time critical nature. A business traveler, for example, may need to visit a customer in a city where every hotel appears to be sold out. Using the service, the traveler may identify or request for desired accommodations at a hotel subscribed to or participating in the service. The traveler may provide an offer for one or more nights at a specific subscribing hotel. A participating hotel may indicate or present to a user a minimum monetary bid amount for the desired accommodation. The offer may be a direct offer to the subscribed hotel. Alternatively, the offer may be a regional based offer (e.g., an offer to one or more subscribed hotels in a particular geographic area). The offer may include a non-monetary component such as points in a loyalty program sponsored by the hotel.

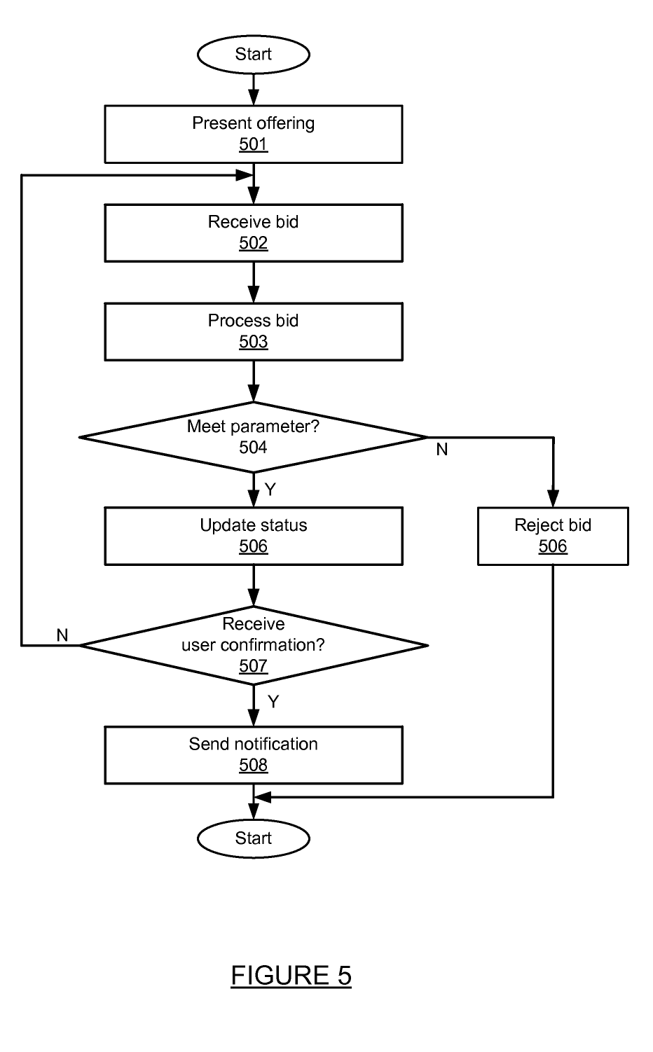

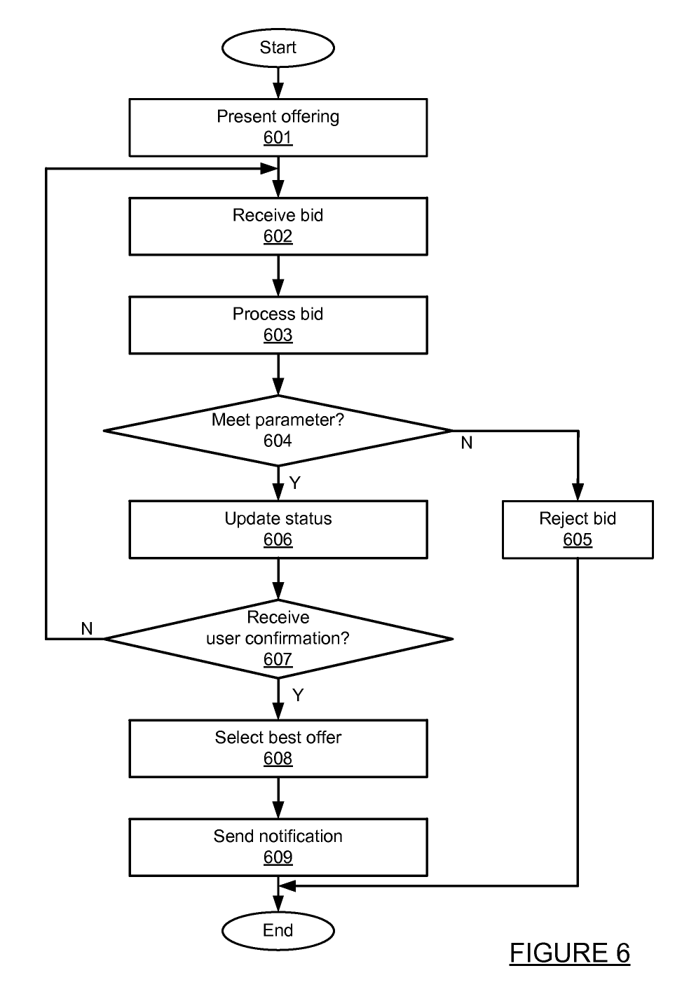

As described in FIGS. 5-6 below, a bid may be subject to a minimum monetary bid amount. If a bid by the user meets a minimum monetary bid amount, the bid may be ranked against one or more bids received from one or more other users of the service and the ranking of the user may be displayed to the user. In accepting the offer, the subscribing hotel may consider other data associated with the business traveler such as transaction history with the subscribed hotel (e.g., the total number of nights previously purchased within a particular time period or the like).

After displaying the ranking to the user, the user may confirm whether the user wishes to be bound to the bid. If it is determined that the bid of the user is the highest bid amongst all bids, the user may receive notification that the user is the highest holds the highest ranking with other bidders.

The service may also be used in the restaurant business. Typically, a restaurant will take walk-in customers and use a traditional “first-come, first-served” queue to service the customers. Outside the scope of the present invention, a customer who has been placed on a waiting list might provide a tip to the host in an effort to move them up on the list. This private exchange between the customer and host is not necessarily a motivating factor for the actual restaurant and also fails to take into account that one or more other customers might also be willing to pay for quicker seating and offer a tip exceeding the tip offered by the first customer.

In one embodiment of the invention, a customer would be able to use the service to offer a payment for quicker seating. The restaurant may accept the customer's offer and seat the customer immediately, move the customer up the wait list based on the offer, or provide additional information or feedback regarding consummating the transaction. By implementing the service and accepting offers and bids, a restaurant is able to increase the satisfaction of patrons that are most willing to support the business. In another embodiment, the restaurant may specify one or more parameters that the customer must meet before the offer by the customer is accepted.

Other opportunistic and time critical offerings may be served by embodiments of the present invention, including plays, operas, and sporting events. During a play or other performance, for example, a large body of people leaves the theater en masse during an intermission in an attempt to obtain drinks and/or snacks. In this scenario, a user may enter an order for food or drinks via a communication device that would relay the order to a service provider. A service provider may then prepare the order in advance so that the order is ready for pick-up at a preferred line at the beginning of intermission. The user is able to save time and avoid the hassle of standing in line for the food or service. Payment may be rendered at the time the order is placed and processed via the communication device or collected at the time of pick-up. A service provider may charge a surcharge or fee to the user for the expedited service or to guarantee that the user's order is available for pick-up.

The communication device described herein allows for wireless communication or network access. The communication device may be any computing device known in the art such as a workstation, lap top computer, mobile device, tablet device, or other computing device. The communications device may include hardware and software such as an application that determines the present location of the user, such as for example a module that determines geographical location using Global Positioning System (GPS). The application and/or hardware is also capable of recognizing (or integrating with additional software and/or hardware components that are capable of recognizing) the location of entities or venues offering potential opportunities that might be of interest to the user, such as for example by accessing a local or remote database of entity or venue information. The application may recommend offerings to the user based on the real-time location of the user and/or information maintained in a user profile accessible over a network connection or stored at the communication device.

The application may also integrate with travel-based applications to access data related to upcoming travel plans and itineraries as well as executing a particularized search function. The application may be further integrated with databases containing data reflecting future consumption opportunities or offerings such as restaurant engagements, sporting events, airline flights, and conferences.

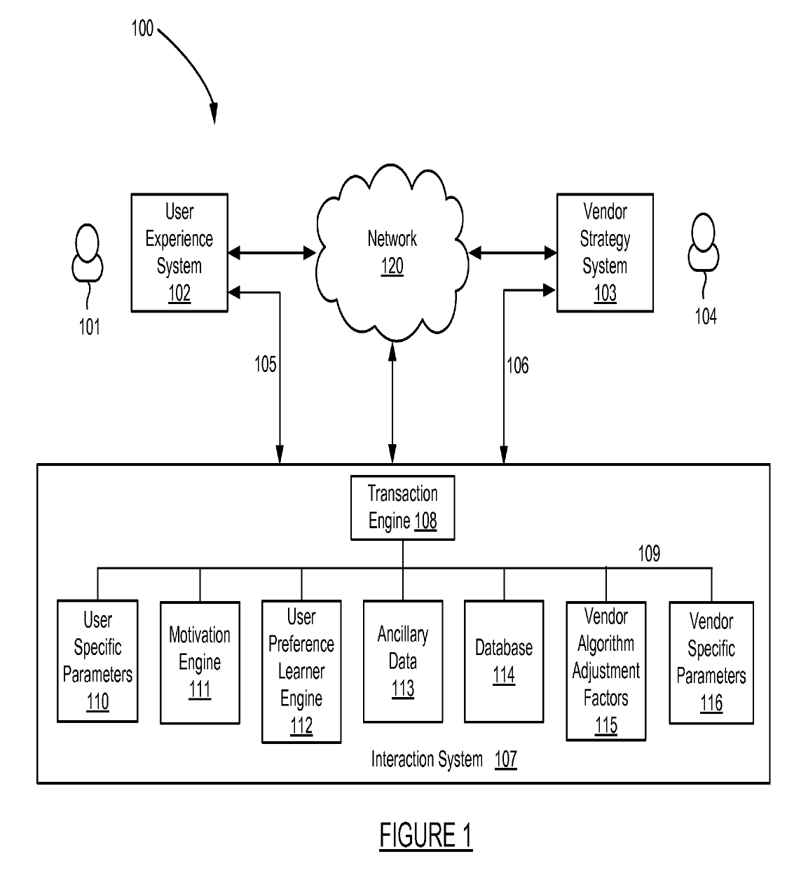

FIG. 1 illustrates a system 100 for a transaction process between a user 101 and a vendor 104. The system 100 includes user experience system 102, vendor strategy system 103, and interaction system 107. Each of systems 102, 103, and 107 may communicate directly with each other, for example wired channels 105 and 106, or indirectly over network 120. Network 120 may include one or more private networks, public networks, LANs, WANs, the Internet, an intranet, a Wi-Fi network, cellular network, or a combination of these networks.

User 101 of FIG. 1 initiates a transaction with the user experience system 102. The user experience system 102 may be a standalone device (e.g., kiosk) or may be integrated with any computing device known in the art such as a lap top computer or mobile device. The user experience system 102 interfaces (either directly or by means of an intermediate system) with the interaction system 107 and vendor strategy system 103. Vendor strategy system may allow vendor 104 to review bids on goods or services and receive input from the vendor 104 regarding which bid to proceed with. The user experience system 102 receives an indication of an interest in a transaction from user 101 and provides feedback to user 101, for example via a display, regarding user status or ranking in the transaction process.

The interaction system 107 maintains a profile of the user 101 along with vendor specific parameter databases. The interaction system 107 may be integrated with or separate from the user experience system 102. The interaction system 107 may be accessed by way of a hardwire connection or through the use of any number of wireless protocols over network 120. Interaction system 107 will in many instances be accessed via a network but may obviate that need in a closed system environment. Interaction system 107 includes transaction engine 107, user specific parameters module 110, user preference learner engine 112, ancillary data 113, database 114, vendor algorithm adjustment factors 115, and vendor specific parameters module 116. More of fewer modules may be included in interaction system 107. Each module (including modules and engines 110-116) may include one or more modules, be locally implemented or distributed, and may be stored in memory and executed by one or more processors.

Access to interaction system 107 is provided through the transaction engine 108. Transaction engine 108 may receive transaction requests and responses from user experience system 102 and vendor strategy system 103, as well as transmit requests, responses and other communications with systems 102 and 103. The transaction engine 108 is executable to generate a user profile. The user 101 may register (e.g., create an account) with the service of the present technology and provide data that may be used to create a profile of the user 101.

In generating the user profile, the transaction engine 108 accesses user specific parameters 110. The user specific parameters 110 may include data provided by the user 101 such as contact information (e.g., name, home or business address, e-mail address, etc.), personal information (e.g., birthday, gender, occupation, etc.), demographic information, interests, hobbies, preferences, and information about memberships and loyalty programs. The communications between the transaction engine 108 and the modules 110-116 may occur over communications channel 109.

Motivation engine 111 is stored in memory and executable by a processor to provide feedback or encouragement to the user experience system 102 to motivate the continuation of the interaction.

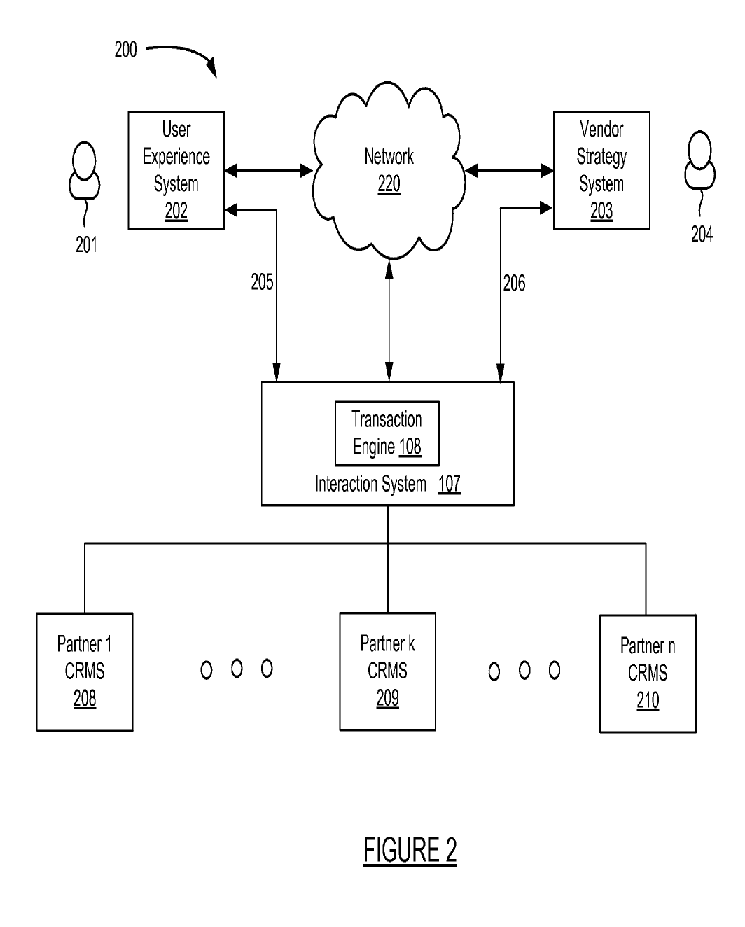

User preference learner engine 112 is stored in memory and executable by a processor to build a profile of the user 101 based on the interactions of user 101 with the user experience system 102. These interactions may include transactions with vendor 104 or with a vendor associated with an affiliated partner CRM system which is discussed in more detail in FIG. 2.

The user experience system 102 may use the generated profile information to recommend opportunities or offerings that are similar to offerings in the historical profile of user 101. For example, if the user 101 has patronized one or more frozen yogurt shops in a certain geographic area within a particular period of time, user preference learner engine 112 may track and store this information in database 114. User experience system 102 may use this information to recommend other dessert shops in the area to user 101. The profile of user 101 may be used to adjust the overall value of the user 101 to the vendor 104.

User preference learner engine 112 may also track ancillary data 113. Ancillary data 113 may include intangible data that might have a particular interest to a vendor 104. User experience system 102 may use ancillary data 113 to determine the ranking of a user in a bidding process for a good or service as described in FIGS. 5 and 6. For example, if user 101 was looking to obtain access to a night club and was a famous celebrity, this information (i.e., ancillary data) may be used to elevate the status of user 101 in the queue for entry. Ancillary data 113 may also be used to delay or prevent access of user 101 into a particular venue, if for example, it were reflective of a bad reputation of a given individual (i.e., known to cause trouble or consistently failing to interact well with other club-goers). Ancillary data 113 may be stored in memory separate from or integrated with database 114. Ancillary data 113 may be provided by a user or vendor.

A database 114 can be maintained to assist in establishing the value of the user 101 to a vendor 104. Database 114, for example, may store user history information regarding past business transactions between user 101 and vendor 104. The history contained in the database 114 is akin to establishing an initial line of status credit with the vendor that would be refined based on future transactions. This is similar to when a user switches between one loyalty program to another and an initial status level is provided based on their status with the previous program.

Vendor 104 may also provide system 100 with vendor algorithm adjustment factors 115. Vendor specific parameters 116 may include any preference, characteristic, criterion, attribute, feature or trait associated with a preferred user 104 or transaction. Vendor algorithm adjustment factors 115 or vendor specific parameters 116 may be accessed and used by user experience system 102 to determine the highest bidder in a bidding process for a good or service as described in FIGS. 5 and 6. Vendor algorithm adjustment factors 115 and/or vendor specific parameters 116 may be stored separately from or integrated with database 114.

Vendor 104 may build a profile of a preferred patron or user based on real-time factors (e.g., vendor specific parameters). A night club, for example, may want to manage ratios of the club demographics. The vendor 104 may specify one or more vendor specific parameters 116. For example, vendor 104 may specify minimum pricing or bid amounts placed by user 101. These vendor specific parameters 116 may be used to help align a potential user 101 with a vendor 104. In another example, if the current demographics of the club showed 75% females and 25% males, the vendor 104 may specify a preference for males patrons as a parameter. If the club had a loyalty or membership program, the vendor 104 could further indicate a preference for members over non-members. Based on the one or more vendor specific parameters 116 provided by vendor 104, user experience system 102 may match the good or service offered by vendor 104 to one or more users.

FIG. 2 illustrates a system 200 between a user 201 and vendor 204 as well as different partner customer relationship management systems 208-210. In FIG. 2, the user 201 interacts with the user experience system 202 to initiate an interaction with the vender 204. The vendor 204 interacts with the vendor (k) strategy system 203 to optimize the overall value of their services. The user experience system, 202 can communicate with the transaction engine 207 and other modules of interaction system 107. User experience system 202, vendor strategy system 203, and interaction system 107 may communicate via network 220, which may be similar to network 120. Systems 202 and 203 may also communicate directly with system 107 via channels 205 and 206. Communication channel 205 can be wired or wireless. As in FIG. 1, there is also the possibility of direct communications, specifically with the vendor (k) strategy system 203 via another communication channel 212, which can similarly be wired or wireless.

The vendor (k) strategy system 203 can also communicate to the transaction engine 207 via a communication channel 206, which may operate in a wired or wireless configuration. The transaction engine 207 communicates with affiliated partners CRM systems 208-210. An affiliated partner CRM system 208 may be associated with a provider whose goods or services may or may not be related to the goods or services provided by vendor 204. A provider associated with affiliated partner system 208 and vendor 204 may agree to share information about user 201 (and/or other users that use their respective systems) such as demographic information, purchase and transaction histories, profile information, etc. . . . These communications offer the possibility of providing additional customer or vendor based information that could be used to optimize the overall transaction process.

For example, if vendor 204 was a transportation service company (e.g., limousine service), an affiliated partner CRM system 208 could be associated with a vendor for a live music performance (e.g., concert) while affiliated partner CRM system 209 could be associated with a restaurant. Affiliated partner CRM system 208 may communicate with vendor 204 (e.g., share information about the plans or purchase/transaction history of user 201) and indicate that user 201 is attending a concert. Similarly, affiliated partner CRM system 209 may communicate with vendor 204 to indicate that user 201 holds a 6 pm dinner reservations. With this information about user 201 in hand, vendor 204 may realize the importance of the transportation service to user 201 and offer better service, alternative services, or discounts or deals to user 201. In addition to transaction engine 207 being able to communicate to various partner CRM systems 208 . . . 210, the vendor (k) strategy system can also communicate with an affiliated CRM system 209 via a wired or wireless communications channel 211.

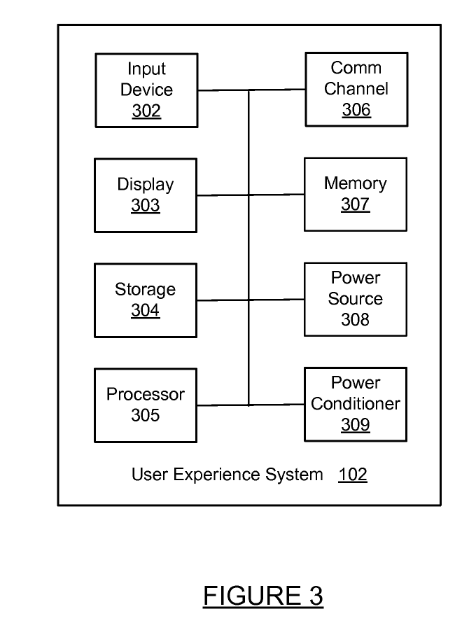

FIG. 3 illustrates a user experience system 300. As one skilled in the art of system design will recognize, various implementations of system 300 are possible. System 300 may include input device 302, display 303, storage 304, processor 305, communication channel 306, memory 307, power source 308, and power conditioner 309.

Input device 302 is inclusive of input devices generally known in the art including a keyboard, a touch screen, a pointing device (e.g., mouse, trackball, stylus), IR input, and audio input. Input device 302 may receive graphical and/or textual information. Display 303 encompasses a full range of multimedia display systems, such as an LCD screen, LEDs, plasma display, and other display devices, as well as speakers and other media output devices. Input device 302 and display 303 are both communicatively coupled to processor 305.

Processor 305 processes data and executes instructions stored in storage 304 and similarly allows for the storage of data in storage device 304 to allow for maintenance of a long term record of user and/or vendor transactions. Memory 307 is also communicatively coupled to processor 305 and may store data for short term or long term maintenance. Memory 307 may also store data and instructions for execution by processor 305. Memory 307 may store executable code when in operation. The execution of instructions by a processor and the storage and retrieval of data from memory or storage is well known to those of ordinary skill in the art.

Communications channel 306 is coupled to the processor 305 for the transfer of information from the user experience system 300 to external and or ancillary components in communication with user experience system 300. Communications channel 306, for example, may receive and transfer communications between a user and vendor. Communications channel 306 is inclusive of a wired based communication port such as an Ethernet port as well as a wireless communication port utilizing a communication protocol such as 802.x. Communication channel 306 may be made secure through operations of processor 305 and any ancillary hardware or software such that transactions may be conducted using the likes of WEP, WPA, TKIP, EAP, LEAP, or PEAP.

User experience system 300 is powered by power source 308, which stores, generates, or is otherwise coupled to the necessary energy to provide the power to the other components within the user experience system 300. Power source 308 may be a battery, a fuel cell, or a coupling to an external power source such as alternating current. Power source 308 may be replenished through the replacement of a battery-like component or re-charging once coupled to an external power source. Power conditioner 309 operates in conjunction with power source 308 to supply the needs of other components within the system 300.

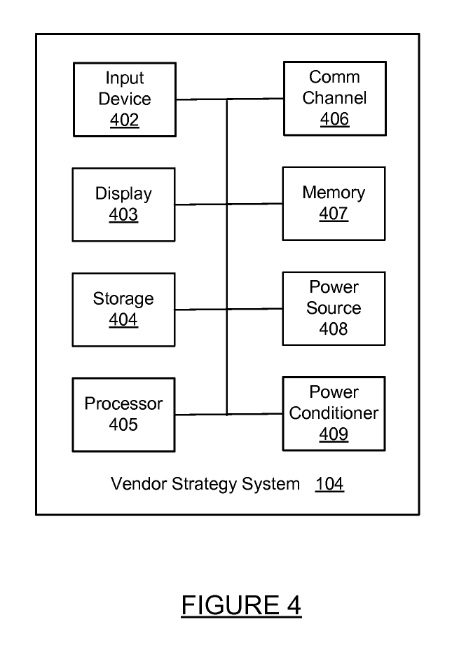

FIG. 4 illustrates an exemplary vendor strategy system 400. Like the user experience system 300, one skilled in the art of system design will recognize various configurations and form factors, which are inclusive of stationary terminals and mobile devices. Vendor strategy system 400 is similar in many respects to the user experience system 300 as described in FIG. 3.

Vendor experience system 400 includes an input device 402, which is similar to the input device 302 of FIG. 3. Display 403 may exhibit similar capabilities as the display 303 of FIG. 3. Input device 402 and display 403 are both in communication with processor 405, which is coupled to storage device 404, memory 407, and communication channel 406, all of which operate and serve in a function similar to those elements as described in FIG. 3. Power source 408 and power conditioner 409 operate in a similar fashion.

FIGS. 5-6 illustrate methods for performing functionality described herein. The steps identified in FIGS. 5-6 (and the order thereof) are exemplary and may include various alternatives, equivalents, or derivations thereof including but not limited to the order of execution of the same. The steps of the method of FIGS. 5-6 (and its various alternatives) may be embodied in hardware or software including a computer-readable storage medium (e.g., optical disc, memory card, etc.) comprising instructions executable by a processor of a computing device.

FIG. 5 illustrates a method 500 for client based interactions in a queue based system. A user may launch or activate the method of FIG. 5 by opening or activating an application in a communication device such as a mobile device. The user may initiate a queue based service interaction with a vendor of goods and/or services. Method 500 may apply to any typical “first-come, first-served” situation for handling customer demands such as in restaurants, movie theaters, and nightclubs where a customer may wait in a line or be placed on a priority list to obtain a desired good or service.

At step 501, the user experience system 102 provides a current listing or advertisement of offerings (e.g., goods and/or services) offered by the vendor to the user and the basic parameters, requirements, or conditions associated with the offerings. The user experience system 102 may generate the listing of offerings tailored to the user based on user specific parameters 110 (e.g., the user profile), ancillary data 113, database 114, vendor algorithm adjustment factors, and vendor specific parameters 116. A listing of the offerings may also be based on the real-time location of the user determined by any method known in the art such as via a global positioning system (GPS).

If the user is interested in an offering by the vendor, the user places an offer or bid for the good or service. The user bid is received by the vendor at step 502. A bid may be monetary, non-monetary, or include both a monetary and non-monetary component. For example, a user may bid a monetary amount or may offer a monetary amount in conjunction with the redemption of loyalty points, a coupon, discount, or other promotion. A non-monetary component may be any additional offering or physical object that the user is willing to offer.

At step 503, the user experience system 102 processes the bid by determining whether the bid meets one or more parameters desired by the vendor. A vendor may specify a minimum monetary bid or offer amount or type of acceptable bid. A vendor may also specify preferred user attributes such as demographic information or membership to a loyalty or rewards program sponsored by the vendor. If the bid by the user does not meet one or more parameters of the vendor at step 504, the bid is rejected at step 505. The user experience system 102 may generate and send a notification (e.g., via Short message service (SMS) message, e-mail message, or the like) to the user that the bid has been rejected (not shown). If the bid does meet one or more vendor parameters, the bid is accepted by the vendor at step 504 and the method proceeds to step 506.

User experience system 102 provides feedback (i.e., status update) from vendor 104 about the user's bid at step 506. The feedback may include providing the current standing or ranking of the user with respect to other users in the queue based on the vendor's perceived value of the bid. The user experience system 102 determines the ranking of a user based on one or more user specific parameters 110 (e.g., the user profile), ancillary data 113, database 114, vendor algorithm adjustment factors, and vendor specific parameters 116. That is, after receiving an acceptable bid or offer, the vendor may improve the current standing of the user (e.g., advance the user's standing in the queue), provide the good or service immediately to the user (e.g., advance the user to the front of the queue), or keep the user at the original position in the queue (e.g., no change in standing in the queue).

For example, if the vendor was a night club with a membership program seeking to fill the club with more guests, user A (a non-member) may offer a bid of $50 to gain entry while user B (member) may offer $25 and 5,000 membership points. Based on certain preferences, the vendor may choose to place user B higher on the queue than user A. Feedback regarding user standings may be provided publicly on a display at a particular venue and or privately to the user on a computing device such as mobile phone associated with the user.

Based on the feedback from the vendor (i.e., status update), user experience system 102 receives confirmation of the bid from the user. The user may determine if they are satisfied with the current status or ranking at step 507. If the user is not satisfied with the ranking at step 507, the user may place a new or modified bid (step 502). If the user is satisfied, the user may confirm the current offer (e.g., remain bound to the offer) at step 507 and wait for the good or service to be provided in the queue. The user has the option to modify or enter a new bid at any time to further advance the user in the queue. At step 508, the user experience system 102 may generate and send the user a notification that the user is at the front of the queue and/or the service or good is ready to be provided to the user. The notification may be sent via Short message service (SMS) message, e-mail message, or the like.

FIG. 6 illustrates a method 600 for client based interactions in a class based system. Method 600 may apply in any “class based” situation for handling customer demands such as in the transportation industry (e.g., travel by airplane or train) or in any live entertainment event (e.g., a sporting event, concert, ballet, or opera) where a more desirable seat is reflected by a higher price. The steps identified in FIG. 6 (and the order thereof) are exemplary and may include various alternatives, equivalents, or derivations thereof including but not limited to the order of execution of the same. The steps of the method of FIG. 6 (and its various alternatives) may be embodied in hardware or software including a computer-readable storage medium (e.g., optical disc, memory card, etc.) comprising instructions executable by a processor of a computing device.

A user may launch or activate the method of FIG. 6 by opening or activating an application in a communication device such as a mobile device. The user first initiates a class based service interaction with a vendor. At step 601, the vendor provides a current listing or advertisement of offerings (e.g., seat upgrades, available seats) to the user and the basic parameters, requirements, or conditions associated the offerings.

If the user is interested in an offering by the vendor, the user places an offer or bid for the service. A bid may be a monetary amount, non-monetary amount, or include both a monetary and non-monetary component. The user bid is received by the vendor at step 602.

At step 603, the user experience system 102 processes the bid by determining whether the bid meets one or more parameters desired by the vendor. As discussed in FIG. 5, a vendor may specify a minimum monetary bid or offer amount or type of acceptable bid. A vendor may also specify preferred user attributes such as demographic information or membership to a loyalty or rewards program sponsored by the vendor. If the bid by the user does not meet one or more parameters of the vendor at step 604, the bid is rejected at step 605. The user experience system 102 may generate and send a notification (e.g., via Short message service (SMS) message, e-mail message, or the like) to the user that the bid has been rejected (not shown). If the bid meets one or more vendor parameters, the bid is accepted by the vendor at step 604 and the method proceeds to step 606.

At step 606, the user experience system 102 provides feedback (i.e., status update) about the user's bid by showing the current standing or ranking of the user with respect to other users in the bidding process based on the vendor's perceived value of the bid. As discussed in FIG. 5, the user experience system 102 determines the ranking of a user based on one or more user specific parameters 110 (e.g., the user profile), ancillary data 113, database 114, vendor algorithm adjustment factors, and vendor specific parameters 116. That is, after receiving an acceptable bid or offer, the vendor 104 may improve the ranking of the user (e.g., advance the user's standing in the bidding process), provide the service immediately to the user (e.g., declare the user as having the winning bid), or keep the user at the original position (e.g., no change in standing in the bidding process).

For example, in the context of the airline industry where the airline is offering an upgrade to first class, user A may place a bid of $50, user B may place a $100 bid, and user C may place a bid of $50 plus 10,000 frequent flyer points. The user experience system 102 may determine the status or ranking of the bidders showing user B at the top of the list, followed by user C then user A. Feedback regarding user standings may be provided publicly on a display at a particular venue and/or privately to the user on a computing device such as mobile device.

Based on the feedback from the vendor, user experience system 102 receives confirmation of the bid from the user. The user may determine if they are satisfied with the current status or ranking at step 607. If the user is not satisfied with the ranking at step 607, the user may place a new or modified bid (step 602). If the user is satisfied, the user may confirm the current offer (e.g., remain bound to the offer) at step 607. The user may modify or enter a new bid at any time to further advance the ranking of the user.

At step 608, the user experience system 102 determines the winning bid based on vendor specific parameters 116. For example, the winning bid may be the bid having the highest monetary component. The winning bid may be the bid having the highest monetary component and non-monetary component (e.g., highest amount of loyalty points offered). At step 609, the vendor notifies the user that the user has placed a winning bid. The user experience system 102 may generate and send a notification (e.g., via Short message service (SMS) message, e-mail message, or the like) to the user. The notification may be sent via Short message service (SMS) message, e-mail message, or the like.

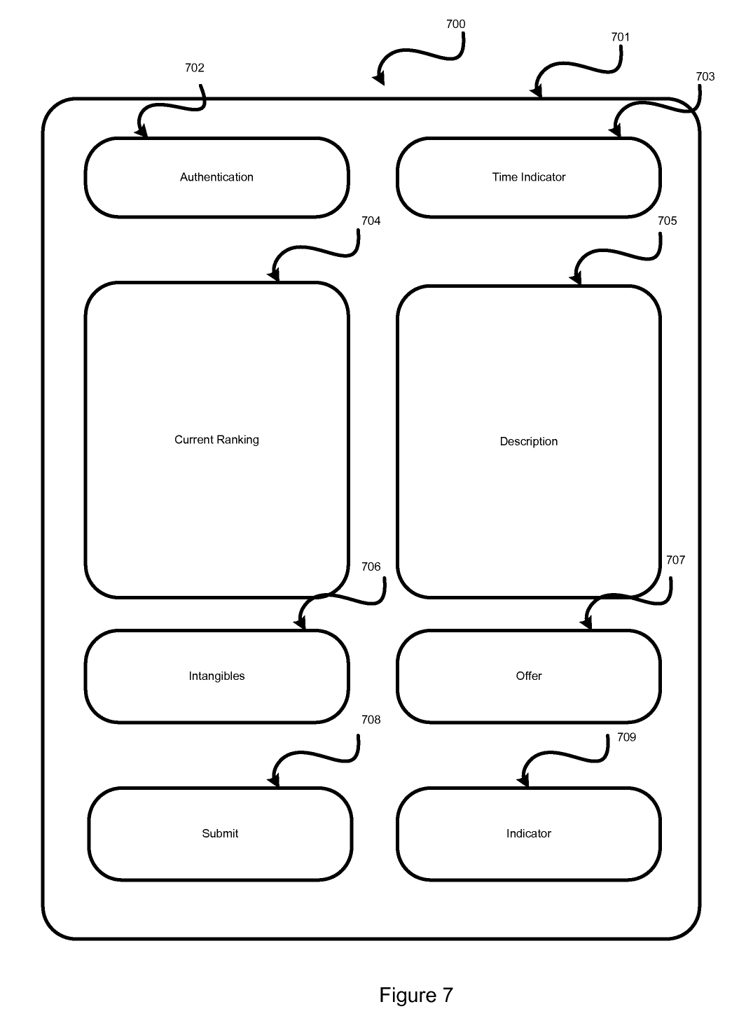

FIG. 7 illustrates a user interface 700 for user interaction. The user interface 700 of FIG. 7 depicts a graphical user interface 701 that may be used for a queue based or class based transaction. In order to access the service provided by the present technology, the graphical user interface 701 may include a field for user authentication 702. The identify of the user may be authenticated by any authentication method or protocol known in the art such as passwords or certificates. Upon selection, the system reconfigures itself based on the type of service being provided.

The graphical user interface 701 may include a time indicator 703. Time indicator 703 may indicate to the user when a final decision from the service provider regarding the requested service will be provided. Time indicator 703 may be in the form of a countdown clock. Time indicator 703 may also be used to show how much time left a user has to place a new or modified bid.

User interface 701 may include a field to display the current ranking of the user for the requested service 704. For example, Current ranking 704 may display a list with the highest bidder at the top of the list. Current ranking 704 may provide additional information such as the number or volume of available opportunities and offerings.

A service or product description field 705 may also be shown in the user interface 701. This information may display the conditions and features of the offered service. In one embodiment, a real-time video feed may be shown in description field 705 to show the venue or location of the offered service. For example, where the vendor is a night club, a live video feed shown in description field 705 might show the club atmosphere or additional offers for VIP services.

As discussed in FIG. 5, an offer or bid may include a monetary and/or non-monetary component. In the Intangibles field 706, a user may bid a non-monetary or intangible such as promotions provided by the vendor to the user, the original price paid for current status, or other items that the user might have acquired through their vendors or co-partners loyalty programs (e.g., coupons, discounts).

In the Offer field 707, a user can provide a bid including a purely monetary based offer, a non-monetary offer, or a combination of the monetary offer 707 with the intangibles offer 706. User ranking is determined using a vendor's custom defined algorithm.

User interface 701 may include a Submit field 708. Once the user has entered an offer in the Intangibles field 706 and/or Offer field 707, the user submits or commits to the bid for the good or service by interacting with Submit field 708. Once a user has committed to an offer, a vendor may proceed in ranking the user as discussed in FIGS. 5 and 6. At the end of the bidding process, the user is notified as regarding the acceptance or the rejection of the submitted bid by way of information conveyed through Indicator field 709. For example, Indicator filed 709 may user color coding (e.g., green for a winning bid, red for a rejected bid), symbols, or short phrases or messages. The Indicator field 709 may also inform the user that the good or service is ready for pick-up or user consumption.

The above description is illustrative and not restrictive. Many variations of the invention will become apparent to those of skill in the art upon review of this disclosure. While the present invention has been described in connection with a variety of embodiments, these descriptions are not intended to limit the scope of the invention to the particular forms set forth herein. To the contrary, the present descriptions are intended to cover alternatives, modifications, and equivalents as may be included within the spirit and scope of the invention as defined by the appended claims and otherwise appreciated by one of ordinary skill in the art.

What is claimed is:

1. A method for acquiring a good or service, comprising:
receiving a request for a good or service offered by a provider, wherein the request is received from a user of one of a plurality of users, the user associated with a communication device;
presenting to the user a minimum monetary bid for the good or service;
receiving a monetary bid from the user for the good or service;
determining that the bid from the user meets the minimum monetary amount;
ranking the bid from the user against one or more bids received from the plurality of users; and
displaying the ranking of the user on an interface of the communication device.

2. The method of claim 1, further comprising:
receiving confirmation from the user that the user remains bound to the bid;
determining that the bid is a highest bid amongst all bids; and
notifying the user that the user has the highest ranking amongst the plurality of users.

3. The method of claim 1, wherein the bid includes a non-monetary component.

4. The method of claim 4, wherein the non-monetary component includes points associated with membership with a rewards program sponsored by the provider.

5. The method of claim 1, wherein the ranking of the bid is based on ancillary data, the ancillary data including information about a reputation of the user.

6. The method of claim 1, wherein the ranking of the bid is based on a vendor specific parameter, wherein the vendor specific parameter includes demographic information associated with the user.

7. The method of claim 1, wherein the ranking of the bid is based on a history of transactions between the user and the provider.

8. The method of claim 1, further comprising receiving a subsequent monetary bid from the user when ranking the bid from the user against one or more bids received from the plurality of users indicates that the bid is not the highest bid.
